(19) United States
(12) Patent Application Publication
(10) Pub. No.: US 2017/0171529 A1
(43) Pub. Date: Jun. 15, 2017

(54) 3D VIDEO RECORDING DEVICE, PROCESSING METHOD, AND ELECTRONIC DEVICE

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventor: Ruike LI, Beijing (CN)

(73) Assignees: LE HOLDINGS (BEIJING) CO., LTD., Beijing (CN); LE SHI INTERNET INFORMATION & TECHNOLOGY CORP., BEIJING, Beijing (CN)

(21) Appl. No.: 15/241,117

(22) Filed: Aug. 19, 2016

Related U.S. Application Data
(63) Continuation of application No. PCT/CN2016/089530, filed on Jul. 10, 2016.

(30) Foreign Application Priority Data
Dec. 14, 2015 (CN) 2015109266908

(51) Int. Cl. H04N 13/02; G02B 5/08; G02B 7/182; H04N 5/225; H04N 13/00

(52) U.S. Cl. CPC H04N 13/0217; H04N 5/2252; H04N 5/2254; H04N 13/0007; H04N 13/0055; H04N 13/0235; H04N 13/004; G02B 7/182; G02B 5/08; H04N 2213/001

(57) ABSTRACT

A 3D video recording device, a 3D video processing method, and an electronic device, are provided wherein the recording device includes a camera and further includes: a baffle located in the middle of the camera and vertical to the camera; a first reflective mirror, and a second reflective mirror parallel to the first reflective mirror and used to receive light reflected by an object in front of the camera and reflect the light to the first reflective mirror, so that the first reflective mirror further reflects the light to the camera; and a second reflective mirror group located at the other side of the baffle including: a third reflective mirror disposed symmetrically to the first reflective mirror with respect to the baffle and a fourth reflective mirror disposed symmetrically to the second reflective mirror with respect to the baffle.

### CROSS-REFERENCE TO RELATED APPLICATIONS

The application is a continuation of PCT application No. PCT/CN2016/089530 submitted on Jul. 10, 2016. The present application claims priority to Chinese Patent Application No. 201510926690.8, filed with the Chinese Patent Office on Dec. 14, 2015, which is incorporated herein by reference in its entirety.

### TECHNICAL FIELD

The present patent application relates to applications of a 3D technology, and specifically, to a 3D video recording device, a 3D video processing method, and an electronic device.

### BACKGROUND

Vision of a person can distinguish a distance because of a difference of two eyes. Except aiming at the front, two eyes see any one object at different angles. Although the difference is very little, the difference is passed to a brain via a retina, the brain uses the slight difference to produce a depth of far and near, so as to produce a stereoscopic impression. According to the principle, the difference between visual angles of the two eyes is used to manufacture two images, then either of two eyes is allowed to see the image on their own respective sides, and the brain may be allowed to produce a stereoscopic impression of depth of field via the retina. Various stereoscopic demonstration technologies also mostly use the principle, which are called “a polarized light principle.” The 3D technology emerges as the foregoing principle. The current 3D technology develops fast, and 3D films have been widely used in cinemas. However, currently, a technology of directly using a mobile device, such as a cell phone or the like, to shoot 3D does not exist, and in particular, for most mobile devices with single cameras, watching a 3D video while shooting cannot be accomplished.

### SUMMARY

The present application provides a 3D video recording device, a 3D video processing method, and an electronic device, where the 3D video recording device and the 3D video processing method may enable people to use an electronic device with a single camera to watch a 3D video while shooting.

According to a first aspect, an embodiment of the present application provides a 3D video recording device, where the recording device includes a camera, and the video recording device further includes: a baffle located in the middle of the camera and vertical to the camera; a first reflective mirror group located at one side of the baffle and including: a first reflective mirror; and a second reflective mirror parallel to the first reflective mirror and used to receive light reflected by an object in front of the camera and reflect the light to the first reflective mirror, so that the first reflective mirror further reflects the light to the camera; and a second reflective mirror group located at the other side of the baffle including: a third reflective mirror disposed symmetrically to the first reflective mirror with respect to the baffle and a fourth reflective mirror disposed symmetrically to the second reflective mirror with respect to the baffle.

According to a second aspect, an embodiment of the present application further provides a 3D video processing method, where the processing method includes: S1) parsing each frame of a video shot by the 3D video recording device stated above into an image to obtain multiple images; S2) cutting the multiple images from the middle into multiple left images and multiple right images; S3) performing incomplete overlapping splicing on the multiple left images and the multiple right images to form multiple ghosting images; and S4) synthesizing the multiple ghosting images into a video.

According to a third aspect, an embodiment of the application further provides an electronic device, including: at least one processor; and a memory. The memory stores a program that can be executed by the at least one processor, and the instructions are executed by the at least one processor, so that the at least one processor can execute any of the foregoing 3D video processing method of the application.

In the 3D video recording device, the 3D video processing method, and the electronic device provided in the embodiments of the application, by means of the foregoing technical solutions, in the 3D video recording device provided by some embodiments of the present application, a baffle divides a camera into two parts, wherein a left part uses a first reflective mirror and a second reflective mirror in a first reflective mirror group to reflect an object to the left side of the camera, and a right part uses a third reflective mirror and a fourth reflective mirror in a second reflective mirror group to reflect the object to the right side of the camera, to ensure that an image shot by the camera is divided into a left part and a right part. In the 3D video processing method provided in some embodiments of the present application, each frame of the foregoing image having two parts is parsed to make the image become multiple images, and the multiple images are cut from the middle and are subjected to incomplete overlapping splicing to form a ghosting image, and finally, a video is synthesized. Embodiments of the present application may enable people to use a mobile device with a single camera to watch a 3D video while shooting.

### BRIEF DESCRIPTION OF THE DRAWINGS

One or more embodiments are exemplarily described by figures corresponding thereto in the accompanying drawings, and the exemplary descriptions do not constitute a limitation on the embodiments. Elements with the same reference numbers in the accompanying drawings represent similar elements. Unless otherwise particularly stated, the figures in the accompanying drawings do not constitute a scale limitation.

FIG. 1 is a schematic structural diagram of a 3D video recording device provided by Embodiment 1 of the present application;

FIG. 2 is a schematic diagram of an image shot by a 3D video recording device provided by Embodiment 1 of the present application;

FIG. 3 is a flowchart of a 3D video processing method provided by Embodiment 1 of the present application; and

FIG. 4 is a schematic structural diagram of an electronic device provided by Embodiment 3 of the present application.

### DESCRIPTION FOR REFERENCE SIGNS

| | | | |
|---|---|---|---|
| 1 | baffle | 2 | housing |
| 3 | first reflective mirror | 4 | second reflective mirror |
| 5 | third reflective mirror | 6 | fourth reflective mirror |
| 11 | 3D video recording device | 12 | receiving apparatus |
| 13 | processing apparatus | | |

### DETAILED DESCRIPTION

To make the objectives, technical solutions, and advantages of the application clearer, hereinafter, the technical solutions of the application will be clearly and completely described by implementation manners with reference to the accompanying drawings in the embodiments of the application. Apparently, the described embodiments are a part rather than all of the embodiments of the application.

Specific implementation manners of the present disclosure are described in detail with reference to the drawings below. It should be understood that specific implementation manners described herein are only used to describe and explain the present disclosure but are not used to limit the present disclosure.

### Embodiment 1

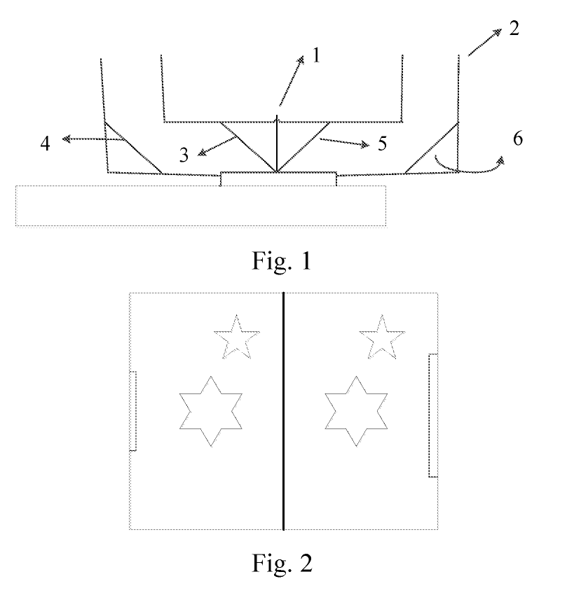

FIG. 1 is a schematic structural diagram of a 3D video recording device provided in some embodiments of the present application. As stated in FIG. 1, this embodiment provides a 3D video recording device, where the recording device includes a camera, and the video recording device further includes: a baffle 1 located in the middle of the camera and vertical to the camera; a first reflective mirror group located at one side of the baffle 1 and including: a first reflective mirror 3; and a second reflective mirror 4 parallel to the first reflective mirror and used to receive light reflected by an object in front of the camera and reflect the light to the first reflective mirror 3, so that the first reflective mirror 3 further reflects the light to the camera; and a second reflective mirror group located at the other side of the baffle 1 and including: a third reflective mirror 5 disposed symmetrically to the first reflective mirror 3 with respect to the baffle 1 and a fourth reflective mirror 6 disposed symmetrically to the second reflective mirror 4 with respect to the baffle 1.

The baffle 1 is located in the middle of the camera and effectively separates light on two sides of the baffle 1, ensuring that the camera can be successfully divided into two parts to shoot an object; the first reflective mirror group and the second reflective mirror group completely correspond about the baffle 1, and the light reflected by a shot object may be reflected to the camera in two separate similar paths. Light at the left side of the baffle 1 is reflected to the camera by the second reflective mirror 4 and the first reflective mirror 3, and light at the right side of the baffle 1 is reflected to the camera by the fourth reflective mirror 6 and the third reflective mirror 5. Here, it is most preferred that the first reflective mirror 3 and the third reflective mirror 5 form an angle of 45 degrees with the camera, and it is most preferred that the second reflective mirror 4 and the fourth reflective mirror 6 are respectively parallel to the first reflective mirror 3 and the third reflective mirror 5, however, which are not limited thereto.

An image shot by the 3D video recording device is roughly as shown in FIG. 2. In FIG. 2, a black line exists in the middle of the image; a pentagram and a hexagram in the left image are the same objects as a pentagram and a hexagram in the right image; same as human eyes, the left image and the right image are basically the same, but slightly different; the left image shoots a part of an object at the left (such as half a rectangle at the left side in the figure) because a left part of the camera is located to the left, and the right image shoots a part of an object at the right (such as half a rectangle at the right side in the figure) because a right part of the camera is located to the right.

In this embodiment, the device further includes a telescopic apparatus used to enable the second reflective mirror 4 and the fourth reflective mirror 6 to move towards an opposite direction during extension and retraction to separately enlarge/reduce a distance between the first reflective mirror 3 and the third reflective mirror 5.

When a user wants to shoot a wider range, the user may select the telescopic apparatus, so that the second reflective mirror 4 is away from the first reflective mirror 3, and the fourth reflective mirror 6 is away from the third reflective mirror 5 at the same time. Similarly, if the user wants to shoot a smaller range, the user may use the telescopic apparatus to make the second reflective mirror 4 closer to the first reflective mirror 3 and also make the fourth reflective mirror 6 closer to the third reflective mirror 5.

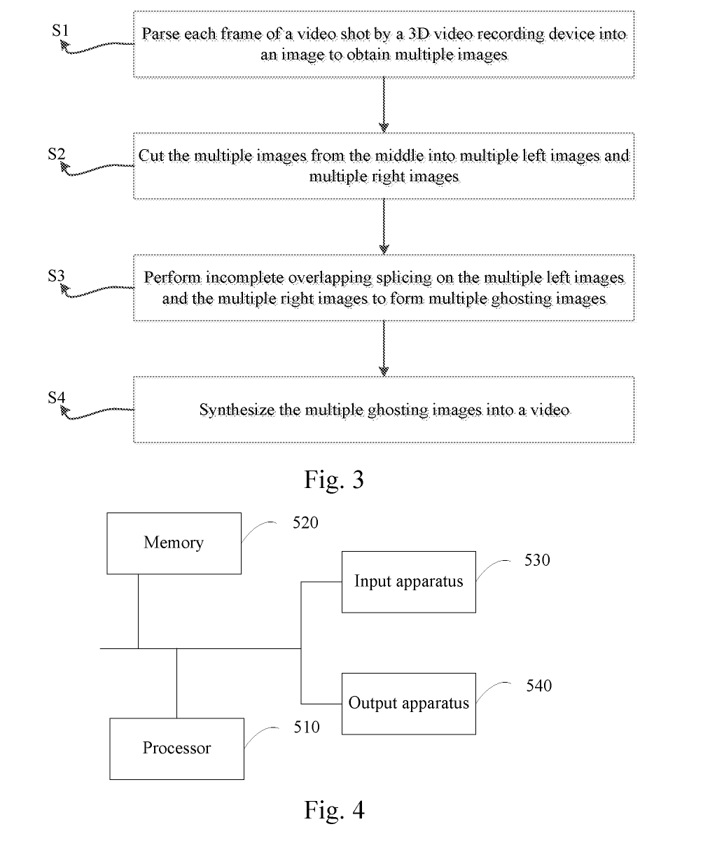

FIG. 3 is a flowchart of a 3D video processing method provided in some embodiments of the present disclosure. As shown in FIG. 3, a 3D video processing method includes: S1) parsing each frame of a video shot by the 3D video recording device stated above into an image to obtain multiple images; S2) cutting the multiple images from the middle into multiple left images and multiple right images; S3) performing incomplete overlapping splicing on the multiple left images and the multiple right images to form multiple ghosting images; and S4) synthesizing the multiple ghosting images into a video.

Step S3) further includes that a distance at which incomplete overlapping splicing is performed on the left image and the right image is a difference of image distance between the first reflective mirror group and the second reflective mirror group, and may also be adjusted by adjusting a sight distance later.

In the foregoing processing process, the most important step is splicing; if the distance between the left image and the right image is not well controlled during splicing, it probably causes weakening of 3D effects or event fails to form 3D effects. If some 3D polarized glasses are used for watching, 3D effects may be adjusted by adjusting glasses; however, if 3D polarized glasses are not adjusted, a distance at which incomplete overlapping splicing is performed on the left image and the right image requires an accurate distance value. After multiple experiments and try-on of glasses, in this embodiment, it is preferably that the distance value is a difference of an image distance between the first reflective mirror group and the second reflective mirror group, and may also be adjusted by adjusting a sight distance later, and is not limited thereto.

As stated above, in the processing method, after processing, people may use polarized 3D glasses for watching; it should be noted that the foregoing processing process not only applies to the video shot by the 3D video recording device stated above but also may process any video similar to the video shot by the 3D video recording device stated above; if a similar film source exists, the 3D video processing method of this embodiment may be directly used for processing.

In this embodiment, the processing method may further include performing red light filtering on the multiple left images and performing blue light filtering on the multiple right images. That is, if an image to be processed is “panchromatic” image (having no obvious red and blue colors and not having red and blue 3D video characteristics), and the image needs to be watched with red and blue glasses, a red and blue light filtering step may be added between the foregoing step S2) and step S3) to perform red light filtering on the left images and perform blue light filtering on the right images.

### Embodiment 2

Embodiment 6 of the application provides a non-volatile computer storage medium, which stores computer executable instructions, where the computer executable instructions can be executed to perform the 3D video processing method in any one of the foregoing method embodiments.

### Embodiment 3

FIG. 5 is a schematic structural diagram of hardware of an electronic device for executing a 3D video processing method provided in Embodiment 7 of the application. As shown in FIG. 5, the device includes:

one or more processors 510 and a memory 520, with one processor 510 as an example in FIG. 5.

A device for executing the 3D video processing method may further include: an input apparatus 530 and an output apparatus 540.

The processor 510, the memory 520, the input apparatus 530, and the output apparatus 540 can be connected by means of a bus or in other manners, with a connection by means of a bus as an example in FIG. 5.

As a non-volatile computer readable storage medium, the memory 520 can be used to store non-volatile software programs, non-volatile computer executable programs and modules, for example, program instructions/module corresponding to the 3D video processing method in the embodiments of the application. The processor 510 executes various functional applications and data processing of the server, that is, implements the 3D video processing method of the foregoing method embodiments, by running the non-volatile software programs, instructions, and modules stored in the memory 520.

The memory 520 may include a program storage area and a data storage area, where the program storage area may store an operating system and at least one application needed by function; the data storage area may store data created according to use of the 3D video recording device, and the like. In addition, the memory 520 may include a high-speed random access memory, and also may include a non-volatile memory, such as at least one disk storage device, flash storage device, or other non-volatile solid-state storage devices. In some embodiments, the memory 520 optionally includes memories remotely disposed with respect to the processor 510, and the remote memories may be connected, via a network, to the 3D video recording device. Examples of the foregoing network include but are not limited to: the Internet, an intranet, a local area network, a mobile communications network, and a combination thereof.

The input apparatus 530 can receive entered digit or character information, and generate key signal inputs relevant to user setting and functional control of the processing device for the 3D video processing operation. The output apparatus 540 may include a display device, for example, a display screen, etc.

The one or more modules are stored in the memory 520, and execute the 3D video processing method in any one of the foregoing method embodiments when being executed by the one or more processors 510.

The foregoing product can execute the method provided in the embodiments of the application, and has corresponding functional modules for executing the method and beneficial effects. The method provided in the embodiments of the application can be referred to for technical details that are not described in detail in the embodiment.

The electronic device in the embodiment of the application exists in multiple forms, including but not limited to:

(1) Mobile communication device: such devices being characterized by having a mobile communication function and a primary objective of providing voice and data communications; such type of terminals including a smart phone (for example, an iPhone), a multimedia mobile phone, a feature phone, a low-end mobile phone, and the like;

(2) Ultra mobile personal computer device: such devices belonging to a category of personal computers, having computing and processing functions, and also generally a feature of mobile Internet access; such type of terminals including PDA, MID and UMPC devices, and the like, for example, an iPad;

(3) Portable entertainment device: such devices being capable of display and play multimedia content; such type of devices including an audio and video player (for example, an iPod), a handheld game console, an e-book, an intelligent toy and a portable vehicle-mounted navigation device;

(4) Server: a device that provides a computing service; the components of the server including a processor, a hard disk, a memory, a system bus, and the like; an framework of the server being similar to that of a general-purpose computer, but higher demanding in aspects of processing capability, stability, reliability, security, extensibility, manageability or the like due to a need to provide highly reliable services; and

(5) Other electronic apparatuses having a data interaction function.

The apparatus embodiments described above are merely schematic, and the units described as separated components may or may not be physically separated; components presented as units may or may not be physical units, that is, the components may be located in one place, or may be also distributed on multiple network units. Some or all modules therein may be selected according to an actual requirement to achieve the objective of the solution of the embodiment.

Through descriptions of the foregoing implementation manners, a person skilled in the art can clearly recognize that each implementation manner can be implemented by means of software in combination with a general-purpose hardware platform, and certainly can be also implemented by hardware. Based on such an understanding, the essence or a part contributing to the relevant technologies of the foregoing technical solutions can be embodied in the form of a software product. The computer software product may be stored in a computer readable storage medium, for example, a ROM/RAM, a magnetic disk, a compact disc or the like, including several instructions for enabling a computer device (which may be a personal computer, a sever, or a network device, and the like) to execute the method described in the embodiments or in some parts of the embodiments.

Finally, it should be noted that the foregoing embodiments are only for the purpose of describing the technical solutions of the application, rather than limiting thereon. Although the application has been described in detail with reference to the foregoing embodiments, a person of ordinary skill in the art should understand that he/she can still modify technical solutions disclosed in the foregoing embodiments, or make equivalent replacements to some technical features therein, while such modifications or replacements do not make the essence of corresponding technical solutions depart from the spirit and scope of the technical solutions of the embodiments of the application.

1. A 3D video recording device, wherein the 3D video recording device comprises a camera, and the 3D video video recording device further comprises:
a baffle located in the middle of the camera and vertical to the camera;
a first reflective mirror group located at one side of the baffle and comprising:
a first reflective mirror; and
a second reflective mirror parallel to the first reflective mirror and used to receive light reflected by an object in front of the camera and reflect the light to the first reflective mirror, so that the first reflective mirror further reflects the light to the camera;
and a second reflective mirror group located at the other side of the baffle and comprising:
a third reflective mirror disposed symmetrically to the first reflective mirror with respect to the baffle and a fourth reflective mirror disposed symmetrically to the second reflective mirror with respect to the baffle.

2. The 3D video recording device according to claim 1, wherein the first reflective mirror and the third reflective mirror form an angle of 45 degrees with the camera.

3. The 3D video recording device according to claim 1, wherein the 3D video recording device further comprises:
a housing used to wrap and fix the baffle, the first reflective mirror group, and the second reflective mirror group.

4. The 3D video recording device according to claim 1 wherein the 3D video recording device further comprises a telescopic apparatus used to enable the second reflective mirror and the fourth reflective mirror to move towards an opposite direction during extension and retraction to separately enlarge/reduce a distance between the first reflective mirror and the third reflective mirror.

5. A 3D video processing method applied to an electronic device, wherein the 3D video processing method comprises:
S1) parsing each frame of a video shot by the 3D video recording device according to claim 1 into an image to obtain multiple images;
S2) cutting the multiple images from the middle into multiple left images and multiple right images;
S3) performing incomplete overlapping splicing on the multiple left images and the multiple right images to form multiple ghosting images; and
S4) synthesizing the multiple ghosting images into a video.

6. The 3D video processing method according to claim 5, wherein a distance at which incomplete overlapping splicing is performed on the multiple left images and the multiple right images is a difference of image distance between the first reflective mirror group and the second reflective mirror group.

7. The 3D video processing method according to claim 5, wherein the processing method further comprises performing red light filtering on the multiple left images and performing blue light filtering on the multiple right images.

8. (canceled)

9. (canceled)

10. (canceled)

11. An electronic device, comprising:
at least one processor; and
a memory in communication connection with the at least one processor, wherein the memory stores instructions that can be executed by the at least one processor, and the instructions are executed by the at least one processor to cause the at least one processor to:
S1) parse each frame of a video shot by the 3D video recording device according to claim 1 into an image to obtain multiple images;
S2) cut the multiple images from the middle into multiple left images and multiple right images;
S3) perform incomplete overlapping splicing on the multiple left images and the multiple right images to form multiple ghosting images; and
S4) synthesize the multiple ghosting images into a video.

12. The electronic device according to claim 11, wherein a distance at which incomplete overlapping splicing is performed on the left image and the right image is a difference of image distance between the first reflective mirror group and the second reflective mirror group.

13. The electronic device according to claim 11 wherein the electronic device is further caused to filter red light on the multiple left images and to filter blue light on the multiple right images.
